(19) United States
(12) Patent Application Publication
(10) Pub. No.: US 2023/0069747 A1
(43) Pub. Date: Mar. 2, 2023

(54) AUTOMATIC ANALYZING APPARATUS

(71) Applicant: CANON MEDICAL SYSTEMS CORPORATION, Tochigi (JP)

(72) Inventors: Hiroo SHINOHARA, Nasushiobara (JP); Shigeyuki TASHIRO, Kumagaya (JP); Masaaki IWASAKI, Kawasaki (JP)

(73) Assignee: CANON MEDICAL SYSTEMS CORPORATION, Tochigi (JP)

(21) Appl. No.: 17/822,189

(22) Filed: Aug. 25, 2022

(30) Foreign Application Priority Data
Aug. 27, 2021 (JP) 2021-138925
Oct. 29, 2021 (JP) 2021-177257

(51) Int. Cl. B01L 3/00; G01N 35/00; G01N 35/02; G01N 35/10

(52) U.S. Cl. CPC B01L 3/52; G01N 35/00693; G01N 35/025; G01N 35/1009; G01N 2035/00702

(57) ABSTRACT

An automatic analyzing apparatus according to an embodiment includes first and second conveyance paths, a sample dispensing mechanism, and processing circuitry. The first conveyance path conveys a first container rack that holds a container housing the sample. The second conveyance path conveys a second container rack that holds a container housing at least one of a detergent solution for cleaning a probe that dispenses the sample, a diluent for diluting the sample, a buffer solution for mixing the sample, a solution used for a blank test with the sample, and a solution for performing calibration measurement for the apparatus. The sample dispensing mechanism is configured so that the probe can aspirate a liquid in the container of the first container rack and the second container rack. The processing circuitry controls operations of the first conveyance path, the second conveyance path, and the sample dispensing mechanism.

### CROSS-REFERENCE TO RELATED APPLICATIONS

This application is based upon and claims the benefit of priority from Japanese Patent Application No. 2021-138925, filed on Aug. 27, 2021; and Japanese Patent Application No. 2021-177257, filed on Oct. 29, 2021, the entire contents of all of which are incorporated herein by reference.

### FIELD

Embodiments described herein relate generally to an automatic analyzing apparatus.

### BACKGROUND

An automatic analyzing apparatus includes a detergent storage part disposed therein, the detergent storage part housing a detergent for cleaning a sample dispensing probe, a reagent dispensing probe, and the like. Herein, a user is required to replenish the detergent storage part with the detergent when the detergent runs short, so that the detergent storage part is disposed at a position that can be accessed by the user. However, depending on a layout of the automatic analyzing apparatus, for example, the storage part for housing the detergent used for the probe has to be disposed at a position that cannot be accessed by the user in some cases. In this case, the same may apply to a solution such as a diluent, not only to the detergent.

### BRIEF DESCRIPTION OF THE DRAWINGS

FIG. 1 is a block diagram illustrating an example of a configuration of an automatic analyzing apparatus according to an embodiment;

FIG. 2 is a diagram illustrating an example of a configuration of an analysis device of the automatic analyzing apparatus according to the present embodiment; and

FIG. 3 is a flowchart illustrating a procedure for using a shuttle rack as a processing procedure performed by the automatic analyzing apparatus according to the present embodiment.

### DETAILED DESCRIPTION

An automatic analyzing apparatus according to the present embodiment is an automatic analyzing apparatus configured to measure a mixed liquid of a sample and a reagent to analyze components contained in the sample, and includes a first conveyance path, a second conveyance path, a sample dispensing mechanism, and processing circuitry. The first conveyance path conveys a first container rack that holds a container housing the sample. The second conveyance path conveys a second container rack that holds a container housing at least one of a detergent solution for cleaning a probe that dispenses the sample, a diluent for diluting the sample, a buffer solution for mixing the sample, a solution used for a blank test with the sample, and a solution for performing calibration measurement for the automatic analyzing apparatus. The sample dispensing mechanism includes the probe, and is configured so that the probe can aspirate a liquid in the container of the first container rack and a liquid housed in the container of the second container rack. The processing circuitry controls operations of the first conveyance path, the second conveyance path, and the sample dispensing mechanism.

The following describes an embodiment of the automatic analyzing apparatus in detail with reference to the drawings. The embodiment is not limited to the embodiment described below. Content described in one embodiment is basically applied to another embodiment.

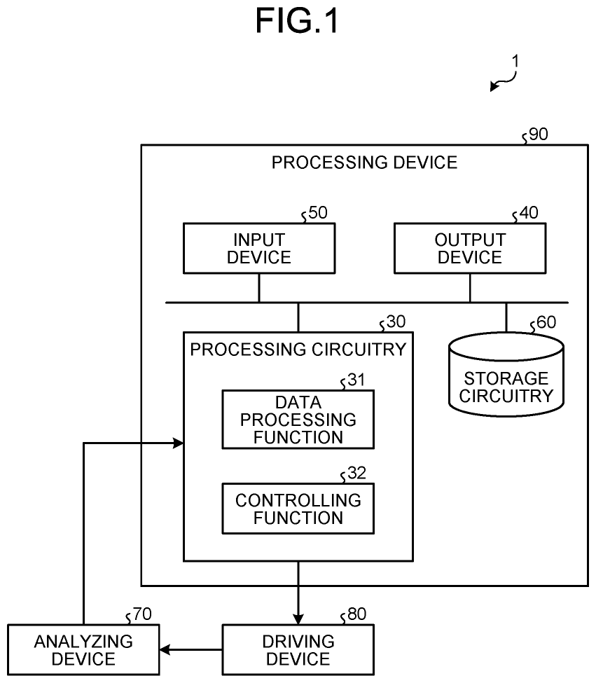

FIG. 1 is a block diagram illustrating an example of a configuration of an automatic analyzing apparatus 1 according to the present embodiment. The automatic analyzing apparatus 1 illustrated in FIG. 1 includes an analyzing device 70, a driving device 80, and a processing device 90.

The analyzing device 70 measures a mixed liquid of a reagent used for analysis of each examination item and a standard sample of each examination item or a test sample taken from a subject (biological sample such as blood and urine), and generates standard data or test data to analyze components contained in the test sample. The analyzing device 70 includes a plurality of units that perform dispensing of a sample, dispensing of a reagent, and the like. The driving device 80 drives the respective units of the analyzing device 70. The processing device 90 controls the driving device 80 to allow the respective units of the analyzing device 70 to operate.

The processing device 90 includes an input device 50, an output device 40, processing circuitry 30, and storage circuitry 60.

The input device 50 includes input devices such as a keyboard, a mouse, a button, and a touch key panel, and performs input for setting an analysis parameter for each examination item, input for setting test identification information of a test sample and an examination item, and the like.

The output device 40 includes a printer and a display. The printer performs printing of data generated by the processing circuitry 30. The display is a monitor such as a liquid crystal display panel, and displays data generated by the processing circuitry 30.

The storage circuitry 60 is, for example, a semiconductor memory element such as a random access memory (RAM) and a flash memory, or a storage device such as a hard disk and an optical disc.

The processing circuitry 30 controls the entire system. For example, as illustrated in FIG. 1, the processing circuitry 30 executes a data processing function 31 and a controlling function 32. The controlling function 32 controls the driving device 80 to allow the respective units of the analyzing device 70 to operate. The data processing function 31 processes standard data or test data generated by the analyzing device 70, and generates calibration data or analysis data of each examination item. The controlling function 32 is an example of a control unit.

For example, the standard data generated by the analyzing device 70 represents data for determining a coagulation time or concentration of biochemical components of blood by examining a test sample (blood), and the test data generated by the analyzing device 70 represents data of results obtained by performing measurement of the coagulation time of blood or colorimetric measurement. The calibration data output from the processing circuitry 30 represents data representing measurement results such as the coagulation time or concentration of biochemical components of blood derived from the test data and the standard data, and the analysis data output from the processing circuitry 30 represents data representing determination results of presence/absence of a morbid state. That is, the calibration data is data for deriving analysis data representing the determination result of presence/absence of a morbid state.

For example, each of processing functions executed by a constituent element of the processing circuitry 30 is recorded in the storage circuitry 60 as a computer-executable program. The processing circuitry 30 is a processor that reads out, from the storage circuitry 60, and executes each computer program to implement a function corresponding to the computer program. In other words, the processing circuitry 30 that has read out each computer program is assumed to have each function illustrated in the processing circuitry 30 of FIG. 1.

In FIG. 1, each processing function described below is assumed to be implemented by a single piece of the processing circuitry 30. Alternatively, the processing circuitry may be configured by combining a plurality of independent processors, and each of the processors may execute a computer program to implement a function.

A word of “processor” used in the above description means, for example, a circuit such as a central processing unit (CPU), a graphics processing unit (GPU), an application specific integrated circuit (ASIC), and a programmable logic device (for example, a simple programmable logic device (SPLD), a complex programmable logic device (CPLD), and a field programmable gate array (FPGA)). In a case in which the processor is a CPU, for example, the processor implements a function by reading out and executing a computer program stored in the storage circuitry 60. On the other hand, in a case in which the processor is an ASIC, for example, the computer program is directly incorporated in a circuit of the processor instead of storing the computer program in the storage circuitry 60. Each of the processors according to the present embodiment is not necessarily configured as a single circuit, but a plurality of independent circuits may be combined and configured as one processor to implement a function thereof. Furthermore, a plurality of constituent elements in FIG. 1 may be integrated into one processor to implement a function thereof.

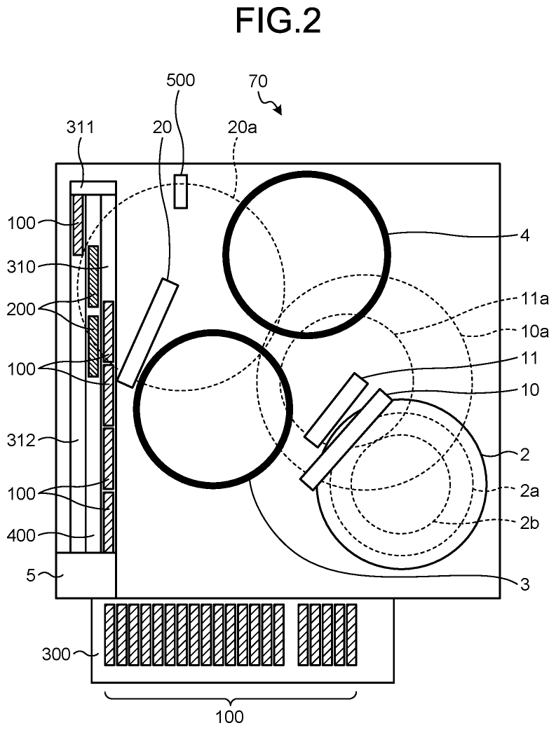

FIG. 2 is a diagram illustrating an example of a configuration of the analyzing device 70 in the automatic analyzing apparatus 1 according to the present embodiment. For example, the automatic analyzing apparatus 1 analyzes a test sample (blood) including an examination item of blood coagulation. Specifically, the automatic analyzing apparatus 1 performs coagulation time measurement or colorimetric measurement for blood collected from the subject.

The analyzing device 70 includes reaction cuvette tables 3 and 4 as reaction chambers. The reaction cuvette tables 3 and 4 hold a plurality of reaction cuvettes disposed on a circumference in a rotatable manner. For example, the reaction cuvette table 3 is a reaction cuvette table for coagulation time measurement, and the reaction cuvette table 4 is a reaction cuvette table for colorimetric measurement. The reaction cuvette tables 3 and 4 are examples of a coagulation reaction cuvette holding part and a colorimetric reaction cuvette holding part, respectively.

The analyzing device 70 further includes a reagent storage 2. The reagent storage 2 holds a plurality of reagent containers disposed on the circumference while keeping them cool. Each of the reagent containers in the reagent storage 2 houses a reagent containing a component that reacts with a component of each examination item contained in the sample (also referred to as a sample). For example, the reagent containers in the reagent storage 2 are arranged on circles 2a and 2b (portions represented by dotted lines in FIG. 2) as concentric circles in the reagent storage 2. The reagent storage 2 includes a turntable that holds the reagent container of each examination item in a rotatable manner.

In FIG. 2, the analyzing device 70 further includes container racks 100 for the sample, a sample dispensing mechanism 20, and a sampling lane 310. The sample dispensing mechanism 20 includes a sample dispensing arm (not illustrated), a sample dispensing probe (not illustrated), and a sample dispensing pump (not illustrated). In the example illustrated in FIG. 2, the sample dispensing arm of the sample dispensing mechanism 20 is illustrated.

The container racks 100 for the sample are disposed on the sampling lane 310. For example, a mechanism for moving each of the containers held by the container racks 100 for the sample to a sampling position is disposed on the sampling lane 310. Movement of the container racks 100 for the sample on the sampling lane 310 is implemented by a conveyor belt, for example.

The sampling lane 310 operates under the control by the controlling function 32 of the processing device 90. Specifically, the driving device 80 allows the sampling lane 310 to convey the container rack 100 for the sample under the control by the controlling function 32. The container rack 100 for the sample is an example of a first container rack.

In the sample dispensing mechanism 20, the sample dispensing probe is disposed at each distal end of the sample dispensing arm, and the sample dispensing pump is connected to the sample dispensing probe via a tube and the like. For example, the sample dispensing arm supports the sample dispensing probe to be capable of rotating and moving upward or downward. In the sample dispensing mechanism 20, each sample dispensing probe moves on a locus 20a (a portion represented by a dotted line in FIG. 2) due to rotation of the sample dispensing arm, and for example, rotates between the sampling position and a sample dispense position. Specifically, the sample dispensing mechanism 20 is configured so that the sample dispensing probe can aspirate a liquid (sample) housed in the container of the container rack 100 for the sample, and configured so that the liquid aspirated by the sample dispensing probe can be dispensed to the reaction cuvette tables 3 and 4. For example, the sample dispensing probe dispenses the sample in the container that is moved to the sampling position. For example, in the sample dispensing mechanism 20, the sample dispensing probe aspirates the sample in the container that is moved to the sampling position for each examination item, and dispenses the sample the amount of which is set as an analysis parameter for the examination item into the reaction cuvette positioned at the sample dispense position in each of the reaction cuvette tables 3 and 4. The sample dispensing pump allows the sample dispensing probe to aspirate and dispense the sample.

The sample dispensing mechanism 20 operates under the control by the controlling function 32 of the processing device 90. Specifically, the driving device 80 allows the sample dispensing mechanism 20 to dispense the sample under the control by the controlling function 32.

In FIG. 2, the analyzing device 70 further includes reagent dispensing mechanisms 10 and 11. Each of the reagent dispensing mechanisms 10 and 11 includes a reagent dispensing arm, a reagent dispensing probe (not illustrated), and a reagent dispensing pump (not illustrated). In the example illustrated in FIG. 2, reagent dispensing arms of the reagent dispensing mechanisms 10 and 11 are illustrated.

In the reagent dispensing mechanisms 10 and 11, reagent dispensing probes are disposed on respective distal ends of the reagent dispensing arms, and the reagent dispensing pump is connected to the reagent dispensing probe via a tube and the like. For example, the reagent dispensing arm supports the reagent dispensing probe to be capable of rotating and moving upward or downward. In the reagent dispensing mechanisms 10 and 11, the reagent dispensing probes respectively move on loci 10a and 11a (portions represented by dotted lines in FIG. 2) due to rotation of the reagent dispensing arms, and for example, rotate between a reagent aspirating position and the reagent dispense position. The reagent dispensing probe dispenses the reagent in the reagent container that has been moved to the reagent aspirating position. Specifically, in the reagent dispensing mechanisms 10 and 11, each of the reagent dispensing probes aspirates the reagent in the reagent container positioned at the reagent aspirating position on each of the circles 2a and 2b in the reagent storage 2, and dispenses the reagent the amount of which is set as the analysis parameter for the examination item into the reaction cuvette positioned at the reagent dispense position in each of the reaction cuvette tables 3 and 4. The reagent dispensing pump allows the reagent dispensing probe to aspirate and dispense the reagent.

The reagent dispensing mechanisms 10 and 11 operate under the control by the controlling function 32 of the processing device 90. Specifically, the driving device 80 allows the reagent dispensing mechanisms 10 and 11 to dispense the reagent under the control by the controlling function 32.

A detergent storage part (not illustrated) is disposed in the reagent storage 2 or in the vicinity of the reagent storage 2, and the detergent storage part houses a detergent for cleaning the reagent dispensing probe during measurement. In the reagent dispensing mechanisms 10 and 11, every time dispensing of the reagent ends, the reagent dispensing probe is cleaned by the detergent in the detergent storage part in the reagent storage 2 or in the vicinity of the reagent storage 2. The detergent storage part in the reagent storage 2 or in the vicinity of the reagent storage 2 is positioned on each of the loci 10a and 11a of the reagent dispensing probe.

The analyzing device 70 further includes first and second mixing devices, first and second photometry units, and a reaction cuvette cleaning unit (not illustrated). Each of the first and the second mixing devices stirs a mixed liquid of the reagent and the sample in the reaction cuvette positioned at a mixing position on the reaction cuvette table 4. The first and the second photometry units measure an optical change in the mixed liquid by applying light to the reaction cuvette housing the mixed liquid. Specifically, each of the first and the second photometry units applies light to the reaction cuvette rotated by each of the reaction cuvette tables 3 and 4 at a measurement position, and detects light, transmitted through the mixed liquid of the sample and the reagent in the reaction cuvette, due to the application of light. Each of the first and the second photometry units then processes a detected signal to generate standard data or test data represented by a digital signal, and outputs the standard data or the test data to the processing circuitry 30 of the processing device 90. The reaction cuvette cleaning unit cleans the inside of the reaction cuvette positioned at a cleaning position on the reaction cuvette table 4.

The sampling lane 310 described above is part of a conveying mechanism for a container rack for a sample. In FIG. 2, the analyzing device 70 further includes, as the conveying mechanism for the container rack for the sample, a front front-disposed sampler 300 (hereinafter, referred to as a front-disposed sampler 300) that is disposed on a front side of the automatic analyzing apparatus 1, a conveyance arm 5, a reading unit (not illustrated), a switch lane 311 (hereinafter, referred to as a lane switching unit 311), and a return lane 312 (hereinafter, referred to as a returning lane 312) in addition to the sampling lane 310.

The front-disposed sampler 300 is disposed on a front side of the automatic analyzing apparatus 1, specifically, on a front side of the analyzing device 70 (a lower side in FIG. 2). The front-disposed sampler 300 includes a put-in slot into which the container rack 100 for the sample that holds a plurality of containers before sampling is put. That is, the container rack 100 for the sample is put in the front side of the analyzing device 70. At this point, the front-disposed sampler 300 moves the container rack 100 for the sample put into the put-in slot to a position at which the conveyance arm 5 can convey the container rack 100 for the sample. The movement of the container rack 100 for the sample by the front-disposed sampler 300 is implemented by a robot arm, for example.

The front-disposed sampler 300 operates under the control by the controlling function 32 of the processing device 90. Specifically, the driving device 80 allows the front-disposed sampler 300 to convey the container rack 100 for the sample under the control by the controlling function 32.

An optical label is given to each of the containers held by the container rack 100 for the sample, the optical label including identification information (for example, patient ID information, a sample ID, and the like) for identifying the sample housed in the container. The optical label is, for example, a barcode.

The conveyance arm 5 is, for example, a robot arm for moving the container rack 100 for the sample. The conveyance arm 5 conveys the container rack 100 for the sample put into the front-disposed sampler 300 to a reading position for the reading unit. The reading unit reads the identification information from the optical label of the container rack 100 for the sample conveyed to the reading position. In a case in which the optical label is a barcode, the reading unit is a barcode reader, for example. The reading unit outputs, as the read identification information, the identification information and the like of the sample such as patient ID information, a sample ID, and an examination item to the processing circuitry 30 of the processing device 90. After the reading is completed by the reading unit, the conveyance arm 5 moves the container rack 100 for the sample from the reading position to be disposed at a starting end of the sampling lane 310.

In FIG. 2, the returning lane 312 is disposed side by side with the sampling lane 310 with a gap therebetween, and the lane switching unit 311 is disposed at a terminal end of the sampling lane 310 and a starting end of the returning lane 312. The terminal end of the sampling lane 310, the starting end of the returning lane 312, and the lane switching unit 311 are disposed on a rear side of the automatic analyzing apparatus 1, specifically, on a rear side of the analyzing device 70 (an upper side in FIG. 2).

The sampling lane 310 moves the container rack 100 for the sample disposed at the starting end of the sampling lane 310 toward the sampling position, and moves the container rack 100 for the sample after sampling to the terminal end of the sampling lane 310 to be disposed at a starting end of the lane switching unit 311. The lane switching unit 311 moves the container rack 100 for the sample disposed at the starting end of the lane switching unit 311 to a terminal end of the lane switching unit 311 to be disposed at the starting end of the returning lane 312. The returning lane 312 moves the container rack 100 for the sample disposed at the starting end of the returning lane 312 to a terminal end of the returning lane 312. The terminal end of the returning lane 312 is a collecting position for the container rack 100 for the sample. The movement of the container rack 100 for the sample by the lane switching unit 311 and the returning lane 312 is implemented by a conveyor belt, for example, similarly to the sampling lane 310.

That is, the sampling lane 310, the lane switching unit 311, and the returning lane 312 operate under the control by the controlling function 32 of the processing device 90. Specifically, under the control by the controlling function 32, the driving device 80 allows the sampling lane 310 to convey the container rack 100 for the sample from the front side of the automatic analyzing apparatus 1 (the front side of the analyzing device 70) to the rear side, allows the lane switching unit 311 to convey the container rack 100 for the sample from the sampling lane 310 to the returning lane 312, and allows the returning lane 312 to convey the container rack 100 for the sample from the rear side of the automatic analyzing apparatus 1 (the rear side of the analyzing device 70) to the front side. The sampling lane 310, the lane switching unit 311, and the returning lane 312 are examples of a first conveyance path. Additionally, the sampling lane 310, the lane switching unit 311, and the returning lane 312 are examples of an outgoing conveyance path, a relay conveyance path, and a returning conveyance path, respectively.

In the automatic analyzing apparatus 1, as described above, for example, the detergent storage part (not illustrated) is disposed in the reagent storage 2 or in the vicinity of the reagent storage 2, and the detergent storage part houses the detergent for cleaning the reagent dispensing probe. Herein, the user is required to replenish the detergent storage part with the detergent when the detergent runs short, so that the detergent storage part is disposed at a position that can be accessed by the user.

However, depending on a layout of the automatic analyzing apparatus 1, for example, the storage part for housing a solution such as the detergent used for the probe has to be disposed at a position that cannot be accessed by the user in some cases. For example, the storage part for housing a solution such as a detergent or a diluent used for the sample probe has to be disposed in some cases.

Thus, the automatic analyzing apparatus 1 according to the present embodiment is configured as follows so that the solution used for the probe can be disposed even at a position that cannot be accessed by the user. The automatic analyzing apparatus 1 according to the present embodiment is an automatic analyzing apparatus configured to measure a mixed liquid of the reagent and the measurement target sample to analyze components contained in the sample, and includes first conveyance paths (the sampling lane 310, the lane switching unit 311, and the returning lane 312), the second conveyance path, the sample dispensing mechanism 20, and the controlling function 32. The first conveyance path conveys the first container rack (container rack 100 for the sample) holding the container housing the sample. The second conveyance path conveys the second container rack that holds the container housing at least one of the detergent solution for cleaning the sample dispensing probe that dispenses the sample, the diluent for diluting the sample, the buffer solution for mixing the sample, the solution used for a blank test with the sample, and the solution for performing calibration measurement for the automatic analyzing apparatus 1. The sample dispensing mechanism 20 includes the sample dispensing probe, and is configured so that the sample dispensing probe can aspirate the liquid housed in the container of the container rack 100 for the sample and the liquid housed in the container of the second container rack. The controlling function 32 controls operations of the first conveyance path, the second conveyance path, and the sample dispensing mechanism 20. Herein, the second container rack on the second conveyance path is conveyed by the second conveyance path from the front side to the rear side of the automatic analyzing apparatus 1 so that the liquid housed in the container of the second container rack can be used in common for the sample housed in the container of the container rack 100 for the sample on the first conveyance path.

The following describes the configuration described above of the automatic analyzing apparatus 1 according to the present embodiment in detail with reference to FIG. 2. In FIG. 2, the analyzing device 70 further includes shuttle racks 200, an exclusive lane 400, and a cleaning unit 500.

First, the following describes the shuttle rack 200. The shuttle rack 200 holds a plurality of containers. The containers held by the shuttle rack 200 respectively house various kinds of solutions such as the detergent solution for cleaning the sample dispensing probe that dispenses the sample, the diluent for diluting the sample, and the buffer solution for mixing the sample. For example, each of the containers held by the shuttle rack 200 houses at least one of the detergent solution, the diluent, the buffer solution, the solution used for a blank test with the sample, the solution for performing calibration measurement for the automatic analyzing apparatus 1. Examples of the solution used for a blank test with the sample include factor depleted plasma, normal plasma, and the like. Examples of the solution for performing calibration measurement for the automatic analyzing apparatus 1 include blank water for correcting a calibration curve, and the like.

The exclusive lane 400 operates under the control by the controlling function 32 of the processing device 90. Specifically, the driving device 80 allows the exclusive lane 400 to convey the shuttle rack 200 under the control by the controlling function 32. The shuttle rack 200 is an example of a second container rack.

An optical label is given to each of the containers held by the shuttle rack 200, the optical label including identification information for identifying various kinds of solutions such as the detergent solution, the diluent, or the buffer solution housed in the container. The optical label is, for example, a barcode.

The conveyance arm 5 conveys the shuttle rack 200 that has been put in to the reading position for the reading unit. For example, the shuttle rack 200 is put into a head position of the front-disposed sampler 300, and the conveyance arm 5 conveys the shuttle rack 200 put into the head position of the front-disposed sampler 300 to the reading position for the reading unit. The reading unit reads the identification information from the optical label of the shuttle rack 200 conveyed to the reading position. In a case in which the optical label is a barcode, the reading unit is a barcode reader, for example. The reading unit outputs the read identification information to the processing circuitry 30 of the processing device 90. After the reading is completed by the reading unit, the conveyance arm 5 moves the shuttle rack 200 from the reading position to be disposed at a starting end of the exclusive lane 400.

The exclusive lane 400 is an exclusive lane for conveying the shuttle rack 200. For example, in FIG. 2, the exclusive lane 400 is disposed side by side with the sampling lane 310 and the returning lane 312 between the sampling lane 310 and the returning lane 312. The exclusive lane 400 moves the shuttle rack 200 disposed at the starting end of the exclusive lane 400 toward the cleaning position or a diluting position, for example. The movement of the shuttle rack 200 by the exclusive lane 400 to the cleaning position or the diluting position is implemented by a conveyor belt, for example.

The exclusive lane 400 operates under the control by the controlling function 32 of the processing device 90. Specifically, the driving device 80 allows the exclusive lane 400 to convey the shuttle rack 200 under the control by the controlling function 32. The exclusive lane 400 is an example of a second conveyance path.

In the sample dispensing mechanism 20, each sample dispensing probe disposed at the distal end of the sample dispensing arm moves to the cleaning position or the diluting position on the locus 20a (the portion represented by the dotted line in FIG. 2) due to rotation of the sample dispensing arm. Specifically, the sample dispensing mechanism 20 is configured so that the sample dispensing probe can aspirate the liquid (various kinds of solutions) housed in the container of the shuttle rack 200. For example, the sample dispensing probe performs a cleaning operation of cleaning the sample dispensing probe by using the detergent solution in the container of the shuttle rack 200 moved to the cleaning position.

The cleaning operation for the sample dispensing probe is performed under the control by the controlling function 32 of the processing device 90. For example, the driving device 80 allows the sample dispensing mechanism 20 to perform the cleaning operation for the sample dispensing probe under the control by the controlling function 32. Specifically, the controlling function 32 controls the sample dispensing mechanism 20 to perform the cleaning operation for the sample dispensing probe by aspirating the detergent solution held by the container of the shuttle rack 200 with the sample dispensing probe and discharging the detergent solution by the cleaning unit 500.

The following operation is performed under the control by the controlling function 32 of the processing device 90. For example, the controlling function 32 controls the sample dispensing mechanism 20 to perform at least one of an operation of dispensing the diluent held by the container of the shuttle rack 200 to the reaction cuvette with the sample dispensing probe, an operation of dispensing the buffer solution held by the container of the shuttle rack 200 to the reaction cuvette with the sample dispensing probe, and an operation of dispensing the solution for performing calibration measurement for the automatic analyzing apparatus 1, the solution being held by the container of the shuttle rack 200, to the reaction cuvette with the sample dispensing probe.

In this way, in the present embodiment, the respective containers of the shuttle rack 200 house various kinds of solutions, and the shuttle rack 200 is conveyed on the exclusive lane 400 arranged in parallel with the sampling lane 310. Therefore, according to the present embodiment, on the locus 20a of the sample dispensing probe, for example, the sample dispensing mechanism 20 can dispense the diluent and the sample to the reaction cuvette at the same position by aspirating the diluent in the container of the shuttle rack 200 on the exclusive lane 400, subsequently aspirating the sample in the container of the container rack 100 for the sample on the sampling lane 310 close to the exclusive lane 400, and discharging the aspirated diluent and sample into the reaction cuvette. In this way, in the present embodiment, the diluent can be directly dispensed into the reaction cuvette to be measured, so that, for example, a multi-step dispensing operation is not required, the multi-step dispensing operation such as preparing a diluted sample by dispensing a sample and a diluent in a container (cell) different from the reaction cuvette, and dispensing the diluted sample into the reaction cuvette.

In the present embodiment, by disposing the sample dispensing probe on the rear side of the automatic analyzing apparatus 1 (rear side of the analyzing device 70), the risk that the user touches the sample dispensing probe during operation can be reduced. Additionally, in the present embodiment, by disposing the sample dispensing probe on the rear side of the automatic analyzing apparatus 1, for example, it is possible to prevent the user from easily accessing the sample and reduce the risk of missassociation of a specimen.

For example, the exclusive lane 400 moves the empty shuttle rack 200 in which various kinds of solutions such as the detergent solution, the diluent, and the buffer solution run out to the starting end of the exclusive lane 400 to be disposed at the collecting position. Herein, in a case in which the shuttle rack 200 returns to the starting end of the exclusive lane 400, the starting end of the exclusive lane 400 becomes the collecting position for the shuttle rack 200. The movement of returning to the starting end of the shuttle rack 200 is, for example, implemented by reverse rotation of a conveyor belt of the exclusive lane 400.

That is, under the control by the controlling function 32 of the processing device 90, the exclusive lane 400 is allowed to convey the shuttle rack 200 from the front side of the automatic analyzing apparatus 1 (front side of the analyzing device 70) to the rear side, and allowed to convey the shuttle rack 200 from the rear side of the automatic analyzing apparatus 1 (rear side of the analyzing device 70) to the front side.

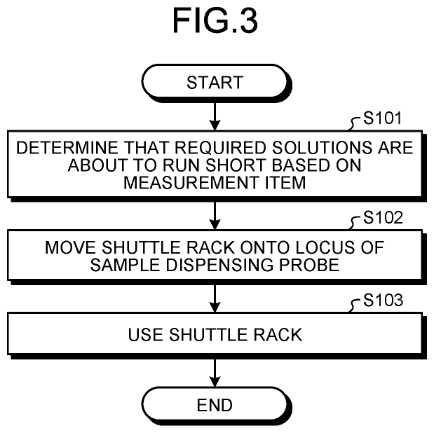

Next, the following describes a procedure for using the shuttle rack 200 as processing performed by the automatic analyzing apparatus 1 according to the present embodiment. FIG. 3 is a flowchart illustrating the procedure for using the shuttle rack 200.

At Step S101 in FIG. 3, the controlling function 32 of the processing device 90 determines that various kinds of solutions such as the detergent solution, the diluent, and the buffer solution in the shuttle rack 200 on the exclusive lane 400 are about to run short based on the examination item or the number of examinations. Cleaning or dilution is performed for the sample dispensing probe per measurement, so that the controlling function 32 of the processing device 90 can grasp a usage amount of various kinds of solutions such as the detergent solution, the diluent, and the buffer solution in the shuttle rack 200 in accordance with the examination item.

At this point, the controlling function 32 of the processing device 90 notifies the user of a screen for calling user's attention during measurement. For example, the controlling function 32 makes notification to the user by causing the output device 40 to output a screen for calling user's attention such as “Put the shuttle rack 200 into the front-disposed sampler 300”. In this case, the controlling function 32 does not stop the measurement but allows a standby state, and the user disposes the shuttle rack 200 on the front-disposed sampler 300. For example, the disposition of the shuttle rack 200 is determined by the user.

Next, at Step S102 in FIG. 3, the controlling function 32 of the processing device 90 moves the shuttle rack 200 onto the locus 20a of the sample dispensing probe. Specifically, the driving device 80 drives the conveyance arm 5 under the control by the controlling function 32 to move the shuttle rack 200 disposed on the front-disposed sampler 300 to the exclusive lane 400. At this point, the exclusive lane 400 is driven by the driving device 80 to dispose the shuttle rack 200 on the locus 20a of the sample dispensing probe.

Next, at Step S103 in FIG. 3, the controlling function 32 of the processing device 90 allows the sample dispensing probe to use various kinds of solutions such as the detergent solution, the diluent, and the buffer solution in the shuttle rack 200. Specifically, under the control by the controlling function 32, the driving device 80 allows the sample dispensing probe to be cleaned by using the detergent solution in the shuttle rack 200 disposed on the locus 20a of the sample dispensing probe, and allows the sample dispensing probe to dilutes the sample by using the diluent in the shuttle rack 200. At this point, the driving device 80 drives the exclusive lane 400 under the control by the controlling function 32 to move, to the collecting position, the empty shuttle rack 200 in which various kinds of solutions such as the detergent solution, the diluent, and the buffer solution run out. The used shuttle rack 200 is collected from the collecting position.

As described above, in the automatic analyzing apparatus 1 according to the present embodiment, the sampling lane 310, the lane switching unit 311, and the returning lane 312 convey the container rack 100 for the sample that holds the container housing the sample. The exclusive lane 400 conveys the shuttle rack 200 that holds the container housing at least one of the detergent solution for cleaning the sample dispensing probe that dispenses the sample, the diluent for diluting the sample, the buffer solution for mixing the sample, the solution used for a blank test with the sample, and the solution for performing calibration measurement for the automatic analyzing apparatus 1. The sample dispensing mechanism 20 includes the sample dispensing probe, and is configured so that the sample dispensing probe can aspirate the liquid housed in the container of the container rack 100 for the sample and the liquid housed in the container of the shuttle rack 200. The controlling function 32 controls operations of the sampling lane 310, the lane switching unit 311, the returning lane 312, the exclusive lane 400, and the sample dispensing mechanism 20. Herein, the shuttle rack 200 on the exclusive lane 400 is conveyed by the exclusive lane 400 from the front side to the rear side of the automatic analyzing apparatus 1 so that the liquid housed in the container of the shuttle rack 200 can be used in common for the sample housed in the container of the container rack 100 for the sample on the first conveyance path (the sampling lane 310, the lane switching unit 311, and the returning lane 312). Thus, in the automatic analyzing apparatus 1 according to the present embodiment, various kinds of solutions such as the detergent solution, the diluent, and the buffer solution used for the sample dispensing probe can be disposed by the shuttle rack 200 and the exclusive lane 400 even at a position that cannot be accessed by the user.

Furthermore, in the automatic analyzing apparatus 1 according to the present embodiment, various kinds of solutions such as the detergent solution, the diluent, and the buffer solution used for the sample dispensing probe are disposed by the shuttle rack 200 and the exclusive lane 400, so that a storage part for housing the solution is not required to be disposed at a position that cannot be accessed by the user. Thus, in the present embodiment, a degree of freedom in the layout of the automatic analyzing apparatus 1 is increased, and a space in which the storage part is not disposed can be effectively used.

According to at least one embodiment described above, the solution used for the probe can be disposed even at a position that cannot be accessed by the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An automatic analyzing apparatus configured to measure a mixed liquid of a reagent and a measurement target sample to analyze components contained in the sample, the automatic analyzing apparatus comprising:
a first conveyance path configured to convey a first container rack that holds a container housing the sample;
a second conveyance path configured to convey a second container rack that holds a container housing at least one of a detergent solution for cleaning a probe for dispensing the sample, a diluent for diluting the sample, a buffer solution for mixing the sample, a solution used for a blank test with the sample, and a solution for performing calibration measurement for the automatic analyzing apparatus;
a sample dispensing mechanism that comprises the probe and configured so that the probe is able to aspirate a liquid housed in the container of the first container rack and a liquid housed in the container of the second container rack; and
processing circuitry configured to control operations of the first conveyance path, the second conveyance path, and the sample dispensing mechanism.

2. The automatic analyzing apparatus according to claim 1, wherein the second container rack on the second conveyance path is conveyed from a front side to a rear side of the automatic analyzing apparatus by the second conveyance path so that the liquid housed in the container of the second container rack is able to be used in common for the sample housed in the container of the first container rack on the first conveyance path.

3. The automatic analyzing apparatus according to claim 1, further comprising:
a coagulation reaction cuvette holding part configured to hold a plurality of reaction cuvettes for coagulation measurement; and
a colorimetric reaction cuvette holding part configured to hold a plurality of reaction cuvettes for colorimetric measurement, wherein
the sample dispensing mechanism is configured to be able to dispense the liquid aspirated by the probe to the coagulation reaction cuvette holding part and the colorimetric reaction cuvette holding part.

4. The automatic analyzing apparatus according to claim 1, wherein the first conveyance path and the second conveyance path are disposed side by side, and respectively convey the first container rack and the second container rack at least from a front side to a rear side of the automatic analyzing apparatus.

5. The automatic analyzing apparatus according to claim 1, wherein
the first conveyance path comprises:
an outgoing conveyance path configured to convey the first container rack from a front side to a rear side of the automatic analyzing apparatus;
a returning conveyance path configured to convey the first container rack from the rear side to the front side of the automatic analyzing apparatus; and
a relay conveyance path configured to convey the first container rack from the outgoing conveyance path to the returning conveyance path.

6. The automatic analyzing apparatus according to claim 1, further comprising: a cleaning unit configured to clean the probe, wherein
the processing circuitry controls the sample dispensing mechanism to perform a cleaning operation for the probe by aspirating the detergent solution held by the container of the second container rack by the probe and discharging the detergent solution by the cleaning unit.

7. The automatic analyzing apparatus according to claim 1, wherein
the processing circuitry controls the sample dispensing mechanism to perform at least one of:
an operation of dispensing the diluent held by the container of the second container rack to a reaction cuvette with the probe;
an operation of dispensing the buffer solution held by the container of the second container rack to the reaction cuvette with the probe; and
an operation of dispensing a solution for performing calibration measurement for the automatic analyzing apparatus, the solution being held by the container of the second container rack, to the reaction cuvette with the probe.
